(19) United States
(12) Patent Application Publication
(10) Pub. No.: US 2016/0192615 A1
(43) Pub. Date: Jul. 7, 2016

(54) COLLAPSIBLE COMBINATION PET BED AND ENCLOSURE

(71) Applicant: Michael Parness, Foxfield, CO (US)

(72) Inventor: Michael Parness, Foxfield, CO (US)

(21) Appl. No.: 14/588,885

(22) Filed: Jan. 2, 2015

(51) Int. Cl. A01K 1/03; A01K 7/00; A01K 5/01; A01K 1/02; A01K 1/035

(52) U.S. Cl. CPC A01K 1/034; A01K 1/0245; A01K 1/0353; A01K 5/01; A01K 7/00

(57) ABSTRACT

The invention relates to a novel multiple configuration enclosure and for pets—typically dogs. The enclosure can be configured to be an open bed, a “cuddle corner” with two panels up, a four-sided enclosure or an enclosure with a top. The carrier is outfitted with four support rails and mesh insert panels to create the sides or walls of the carrier. The soft panels have mesh inserts so that the dog may be able to receive sufficient airflow and see outside of the carrier. The molded base is indented to receive a removable padded bed which may then be easily removed for cleaning. The panels break down and are stored in a pull-out drawer in the base, and wheels are attached thereto for easy portability.

### FIELD

The invention relates to a novel indoor/outdoor pet bed and enclosure combination which is portable and easy to operate. The end frames are detachable and front and rear panels store in the base piece are readily pulled up and locked into the frame. The enclosure and bed can be configured in multiple ways depending on the pet owner's needs in a given situation. The bed and enclosure can be fully folded compact for storage and features wheels on the base and a carry handle on the top piece for ease of mobility.

### BACKGROUND OF THE INVENTION

The invention most closely corresponds with USPTO Class 119/416 wherein Class 119 relates to animal husbandry and sub-class 416 includes an oftentimes movable covered enclosure for providing a protective dwelling for a limited number of animals.

In its simplest form, the invention relates to a novel multiple configuration carrier for pets—typically dogs. The enclosure can be configured to be an open bed, a “cuddle corner” with two panels up, a four-sided crate or a carrier with a top. The unit is outfitted with frame pieces and mesh insert panels to create the sides or walls of the enclosure and which mesh panels provide UVA/UVB protection. The soft panels have mesh inserts so that the dog may be able to receive sufficient airflow and see outside of the carrier, as well as be protected from the sun's UV rays. The molded base is indented to receive a removable padded bed which may then be easily removed for cleaning.

The enclosure also has a top or lid which will be lockable via loop hooks which snap over the frame for vehicle transport of a pet, and once to a destination, the owner may remove the top or the top and all four sides to allow the pet to move about freely yet come back to lay on a familiar bed. The front and rear wall panels are easily released and tucked into the base piece. The end panels and frames are removable and store in a slide out drawer designed into the base piece.

A unique feature of the enclosure is the inclusion of a “food bridge” that attaches to both sides of the base and arcs over the bed area. This bridge is easily snapped off the base for cleaning and can receive food and water, games or treats. The base of the enclosure also contains a molded inner track or notch which creates the ability to attach items such as food dishes, toys, games, or bed extensions.

### THE INVENTION

### Summary, Objects And Advantages

Traveling with pets can often be a challenging endeavor. Similarly, containing a pet on a temporary basis can also cause anxiety for the pet and owner. Different types of enclosures or carriers may be required, and most in the art are a fairly enclosed plastic unit with grating on the door where one has to typically cajole the pet to enter. Older dogs may not be as mobile with respect to getting in and out of a vehicle, and feel safer confined in a familiar setting. Comfort as well as safety are key considerations when transporting pets even just a few blocks away from the pet's home. The inventive enclosure has pull down panels like window shades which rest in notches in the base piece. Each panel may be used for easy ingress or egress for the pet as well as shade and a sense of security. There is no typical front “cage” door which can cause anxiety to the pet or the owner.

Once a pet and owner arrive at their destination, the pet can be left inside the enclosure without anxiety of being separated from its owner. The mesh panels provide visibility and plenty of air flow which allows the pet to be less agitated in general. The owner can relax in knowing that their pet is safely and comfortably confined as well as alleviating concern for possible damage done by a free roaming pet.

The inventive enclosure provides a pet owner the liberty to transport various sized dogs as well. Popular backpack pet carriers are not as ergonomic for the animal as a crate type carrier, and obviously cannot be used with larger dogs. Another drawback to a backpack or tote type carrier is there is nowhere to safely confine the pet once at a destination. The inventive carrier is forgiving of pet accidents in that the base and bed pieces are easily removed and washed.

Detachable end frame pieces snap into receiving notches in the base and can be assembled in seconds. Each end piece contains pull-down panels which can be slid down and locked into place in various stages of openings. They do not have to be completely closed though have the ability to be pulled down and locked into the base frame. The mesh panels of the inventive carrier provide an added safety benefit over the prior art carriers or kennels in that they are soft and reduce impact injury in the case or sudden movement in a vehicle or jostling of the carrier. The front and back panels are housed in the base piece and may be rolled up and locked into the frame by a user to create a four-sided enclosure.

The inventive enclosure may be used indoors or out. This flexibility allows the pet owner to leave a pet for short periods of time either indoors or outdoors without the pet being stressed or potentially lost. The multiple wall panel configurations allow for a well trained pet to have just a “cuddle corner” by using two panels or an open top enclosure by using four panels and leaving the top piece off, or a completely enclosed crate. The options are determined by the pet owner based upon the pet's typical behavior.

A further benefit of the inventive enclosure is portability and storage. It is lightweight and disassembled in seconds with the sides and frame being storable in the base. A carrying handle attached to the top piece makes the entire unit a breeze to fold up and carry away. Rather than having to buy multiple crates for varying purposes and different sizes for multiple dogs, the inventive combination enclosure and bed resolves a long felt need in the art.

The base piece of the enclosure has wheels so that the unit may be conveniently wheeled into place when the enclosure is completely open, or folded up for storage. This way a user can easily slide the enclosure with a pet inside to a more convenient location whether indoors or outdoors. Or simply roll the collapsed enclosure into a closet for storage or to a vehicle for transport.

A further embodiment of the bed and enclosure is the ability to mount a “doggie cam” with two-way communication on the internal frame of the enclosure wherein a pet owner can monitor and even communicate with the crated pet. Communication and transmittal of data is accomplished by a Smartphone App, laptop or desktop computer. Similarly, activated toys or feeders may be used in the bridge piece which may be motion activated (RFID) to interact with a pet while the owner is not monitoring the pet. RFID receivers may be affixed to the pet's collar to signal a feeder to release kibble or water, or signal a toy to perform some intended function.

### BRIEF DESCRIPTION OF THE DRAWINGS

The invention is described in further detail by reference to eight (8) drawings sufficient in detail to describe the invention in which:

FIG. 1 is the enclosure completely assembled;

FIG. 2a shows the base piece with bed pad inserted;

FIG. 2b depicts the food bridge;

FIG. 3 illustrates the food bridge in place over the base;

FIG. 4 is the base with drawer open;

FIG. 5 illustrates the enclosure as collapsed with wheels;

FIG. 6 is the enclosure without top and with slideable food bowl;

FIG. 7 is the base piece with bed insert; and

FIG. 8 illustrates the side panels and frames storage.

### DETAILED DESCRIPTION, INCLUDING BEST MODES OF CARRYING OUT THE INVENTION

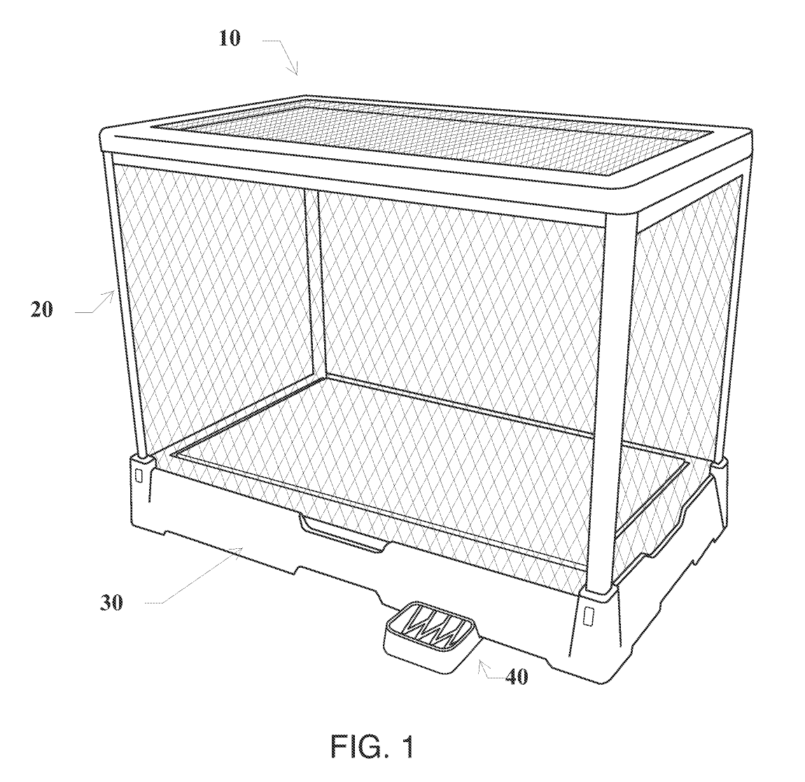

FIG. 1 shows the enclosure with the top 10 affixed. All four mesh panels 20 are inserted to make a full enclosure. The base piece pull-out drawer 30 is shown as well as one of the accessory slideable food dishes 40 as pressed into the notched base.

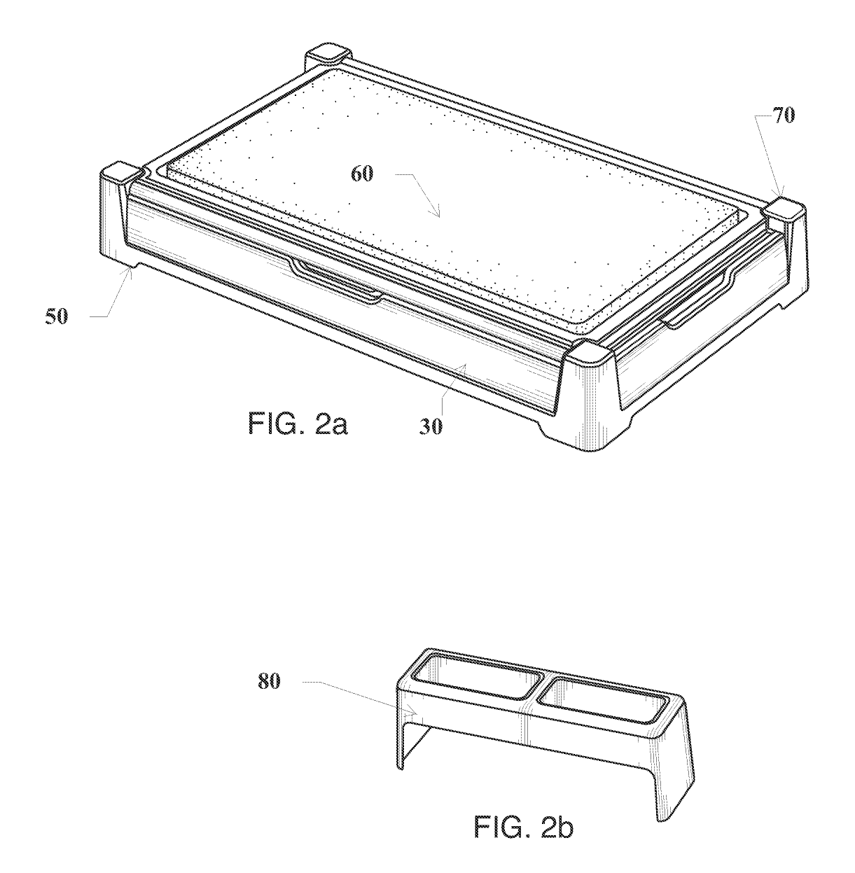

FIG. 2a shows just the base piece 50 with the padded bed 60 inserted. The bed is removable for easy cleaning. The four corners 70 receive the mesh panel frame pieces which snap into the base piece corners. Again the pull-out storage drawer is shown 30.

FIG. 2b is the food bridge 80 which snaps over the base piece and can then be filled with food and water for the bed yet be stable when inside the enclosure with the pet.

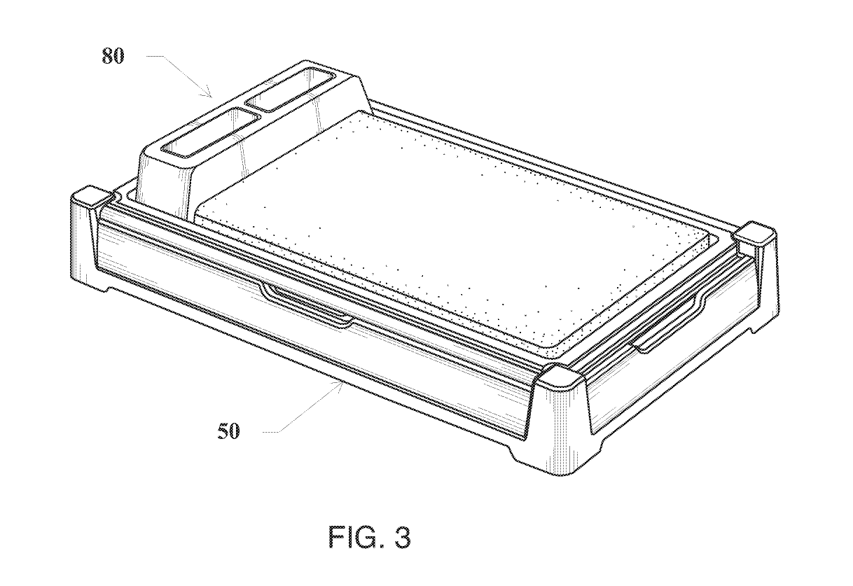

FIG. 3 shows the food bridge 80 as snapped onto the base piece 50.

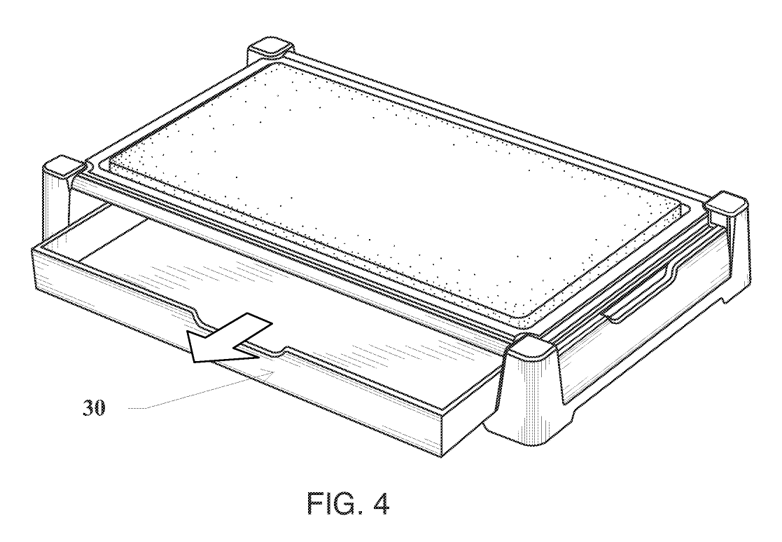

FIG. 4 illustrates the pull-out drawer 30 which is used to store the side panels and top of the enclosure.

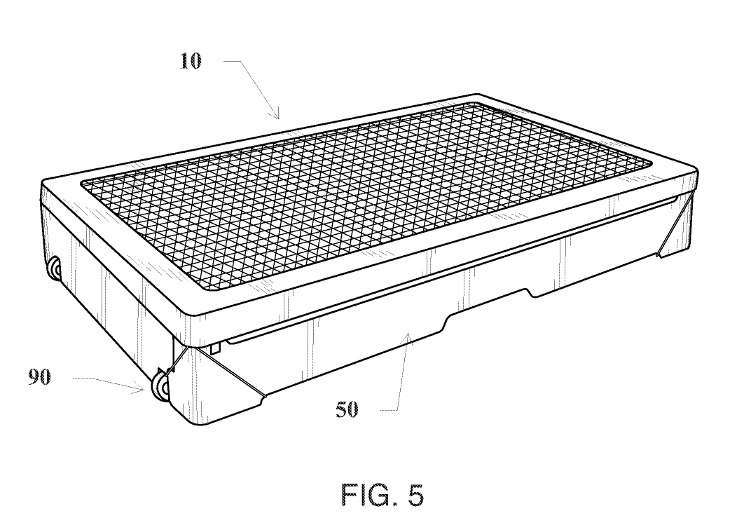

FIG. 5 depicts the entire enclosure as collapsed and ready for moving or storage. The top piece 10 securely snaps to the base piece 50 and the bed and panels are neatly stored within. Wheels 90 are built in to the base piece for easy moving and storage of the collapsed enclosure. Not seen in this Figure is a handle on the back side of the collapsed enclosure for carrying the entire enclosure.

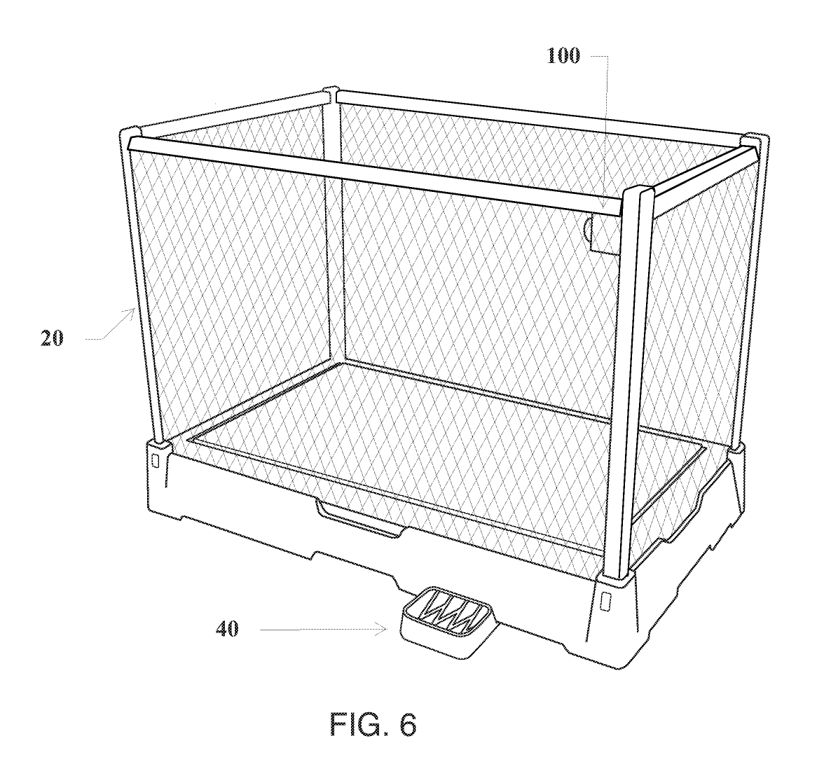

FIG. 6 shows the enclosure with four panels 20 erected, and no top. This configuration tends to make some pets feel more comfortable while still confining them. The food bowl 40 which slideably resides in a notch in the base is also illustrated here. A two-way “doggie cam” 100 is shown as mounted in the enclosure. This media may be controlled by a Smartphone app so the owner may monitor the pet when it is not supervised. The communication of this unit can be both audio and video so that the pet may be able to hear the owner's voice.

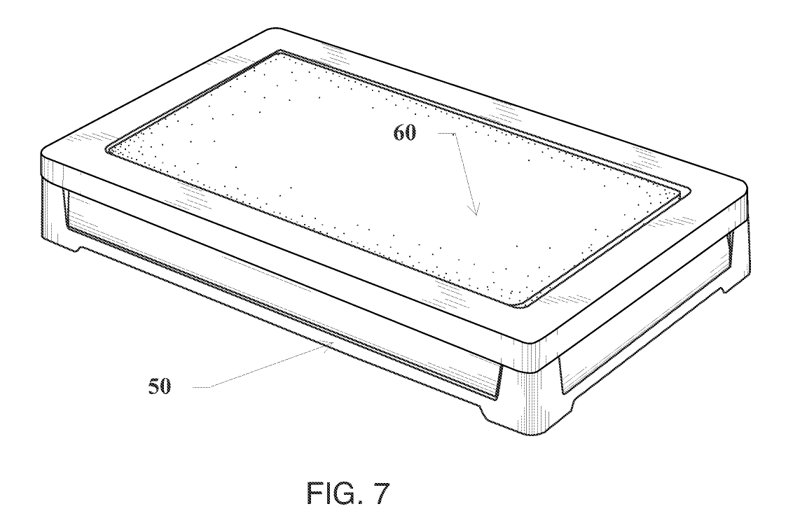

FIG. 7 is a simple illustration of the base piece 50 and the padded bed 60 inserted with no other panels or accessories used. An owner may just want to use the enclosure as a bed only for well behaved pets or for pets that are at home.

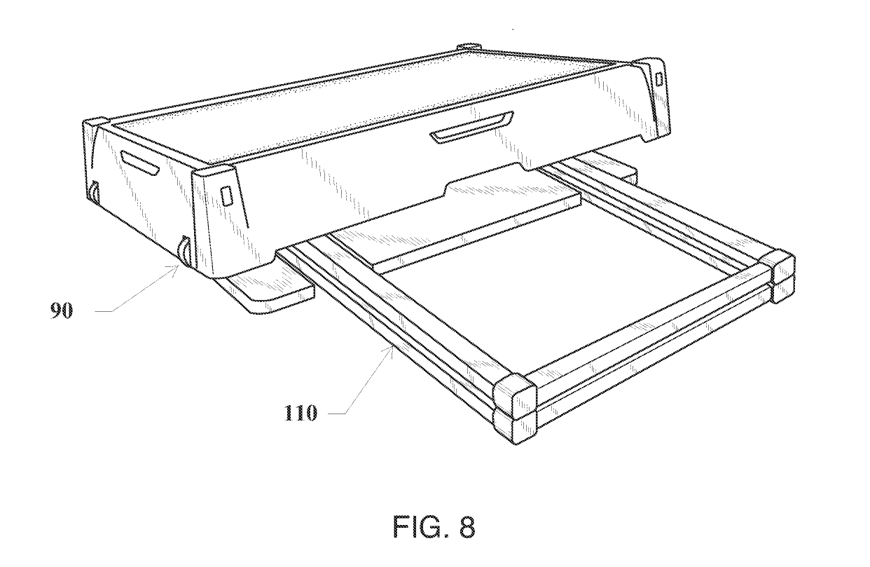

FIG. 8 illustrates the panels as being stored 110 in the base piece. This feature provides for easy storage and mobbing of the enclosure when collapsed. Again the wheels 90 for easy mobility are shown.

1) A collapsible combination pet bed and enclosure comprising:
a) a base piece with molded indentations
b) a storage drawer
c) detachable support rails
d) detachable mesh panels
e) notching for slidable bowls or toys
f) a cover or lid
g) wheels affixed to base
h) two-way communication module.

2) The collapsible combination pet bed and enclosure as in claim 1 wherein the base piece has a removable bridge for food and water and a larger injection molded frame indentation to receive a padded bed.

3) The collapsible combination pet bed and enclosure as in claim 1 wherein a slide out storage drawer is located in the base piece for storage of the support rails and panels.

4) The collapsible combination pet bed and enclosure as in claim 1 wherein detachable support or corner rails fit into insets in the base piece and may be stored in the slide out drawer.

5) The collapsible combination pet bed and enclosure as in claim 1 wherein detachable mesh panels affix to the support rails to make up the walls of the enclosure and are also stored in the slide out drawer in the base piece.

6) The collapsible combination pet bed and enclosure as in claim 1 wherein a notch is created in the base piece to receive bowls or toys which will then be slidably locatable horizontally along the base piece.

7) The collapsible combination pet bed and enclosure as in claim 1 wherein a framed in mesh top piece snaps to the side panels creating a firmly affixed lid or cover.

8) The collapsible combination pet bed and enclosure as in claim 1 wherein the base piece has wheels affixed thereto for portability of the pet bed and enclosure.

9) The collapsible combination pet bed and enclosure as in claim 1 wherein a two-way communication module with audio and video may be mounted inside the pet bed and enclosure.
